(19) United States
(12) Patent Application Publication
(10) Pub. No.: US 2004/0251436 A1
(43) Pub. Date: Dec. 16, 2004

(54) Single detector multicolor particle analyzer and method

(76) Inventors: Philippe Goix, Oakland, CA (US); Paul J. Lingane, Redwood City, CA (US)

Correspondence Address: Aldo D. Test, DORSEY & WHITNEY LLP, Suite 3400, 4 Embarcadero Center, San Francisco, CA, 94111, US

(21) Appl. No.: 10/461,538

(22) Filed: Jun. 12, 2003

(51) Int. Cl. G01N 15/06; G01N 21/49

(52) U.S. Cl. 250/573

(57) ABSTRACT

A multicolor particle analyzer and method is described. The particles which either naturally fluoresce or are tagged to fluoresce at distinctive wavelengths are caused to flow through an analyzing volume where fluorescence is excited by an impinging light beam. A tunable optical filter repetitively and sequentially passes emitted light at each of the characteristic wavelengths and the light transmitted through the optical filter is received by single detector which provides output signals representing particles at each distinct wavelength.

### BRIEF DESCRIPTION OF THE INVENTION

The present invention relates generally to a multicolor particle analyzer or cytometer and method and more particularly to a multicolor particle analyzer and method which employs a single detector.

### BACKGROUND OF INVENTION

Recent developments in flow cytometry hardware and dye chemistry have made it possible to simultaneously measure as many as ten or more fluorescences and scattered light parameters. They provide a large amount of novel information, which permits identification and characterization of cell subsets. However, such multicolor prior art systems are complex and expensive. They require multiple optical paths and detectors and complex control circuits. They are not suitable for portable use, point of care use or battlefield use.

Conventional flow cytometers require hydrodynamic sheet flow to align the particles in a single line in the laser probe volume. The hydrodynamic focusing accelerates the sample and particles and requires relatively large volumes of samples to carry out an analysis. Typically for sample volume flow rates of 1 μ/s and exit velocities of 25-50 mm/s the particle velocities reach 10 m/s when they cross the probe volume. For a probe beam laser width of 20 microns, the particle time of flight through the probe volume is 2 microseconds. Since the particle is present in the probe volume for only a short time, a detection system is required for each color thus leading to complex, expensive and bulky systems.

### OBJECT AND SUMMARY OF THE PRESENT INVENTION

It is an object of the present invention to provide a simple, relatively inexpensive multicolor particle detection system and method.

It is a further object of the present invention to provide a multicolor particle detection system and method which employs a single detector.

It is a further object of the present invention to provide a multicolor particle detection system in which multiple reading of the distinct fluorescence of each particle is obtained during the time of flight of the particle through the probe volume and therefore enables the reconstruction of the fluorescent traces of each color using a single detector.

It is a further object of the present invention to provide a multicolor particle analyzer which employs an acousto-optical notch filter to repetitively sample fluorescent light at different frequencies (color) in a prearranged sequence as particles pass through the analyzing region.

The foregoing and other objects of the invention are achieved by a system in which the sample particles which fluoresce at distinct wavelengths flow slowly through a capillary tube past a detection volume where the particles are excited by a light beam and fluoresce at their characteristic wavelength. The fluorescent light is applied to an acousto-optical notch filter whose pass band changes wavelength in a prearranged manner and whose output is applied to a single detector. The acousto-optical filter shifts to sequentially and repetitively pass the characteristic wavelength of a particle a number of times as it travels through the detection volume. The output of the detector is reconstructed to provide a characteristic fluorescent trace for the particle.

### DESCRIPTION OF THE FIGURES

The foregoing and other objects of the invention will be more clearly understood from the following description when read in connection with the accompanying drawings of which:

FIG. 1 is a schematic diagram of the multicolor particle analyzing system of the present invention;

FIG. 2 is an enlarged view of a portion of the interior of the capillary shown in FIG. 1;

FIG. 3 is a scatter trace for a particle flowing through the analyzing volume;

FIG. 4 shows the traces obtained from four particles tagged to fluoresce at different wavelengths as each individually flows through the detection region;

FIG. 5 shows flow through a capillary independent of whether the sample is aspirated or pumped;

FIG. 6 shows the light wavelength pass bands of the acousto-optic filter as a function of the RF voltage frequency; and

FIG. 7 is a schematic block diagram of a system for controlling the acquisition and detection of fluorescent light from a particle traveling through the analyzing region.

### DESCRIPTION OF PREFERRED EMBODIMENTS

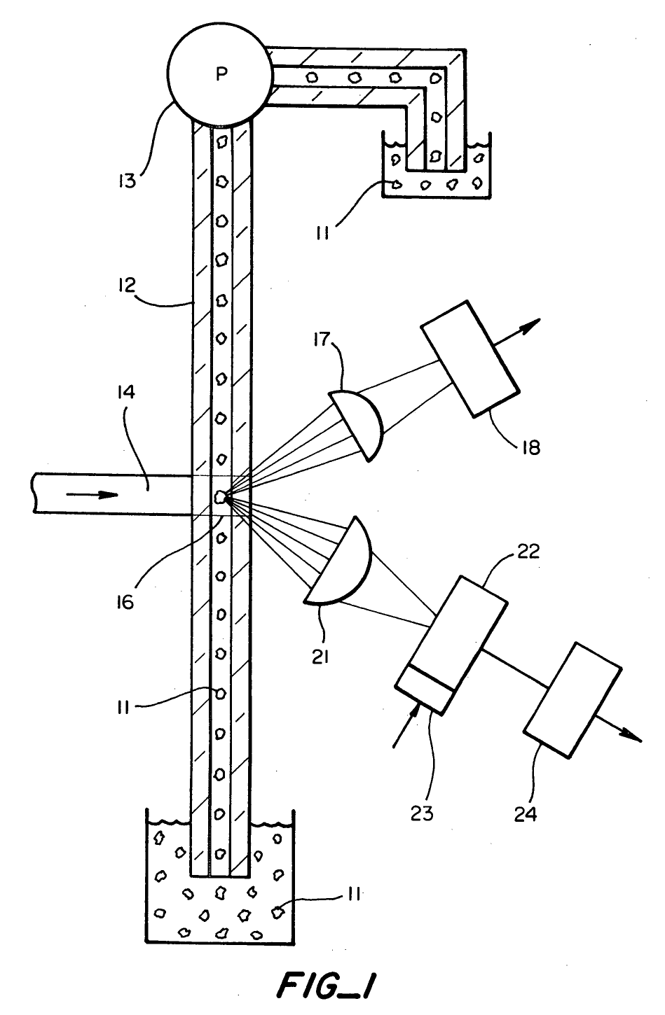

A particle analyzing apparatus for carrying out the invention is shown in FIG. 1. Briefly, a particle suspension 11 containing particles to be analyzed flows through a capillary 12 as shown in FIGS. 1 and 5. Preferably the capillary is a square capillary. The sample with suspended particles is aspirated or drawn through the capillary by a pump 13. A laser or other suitable light source projects a beam 14 through the capillary to define an analyzing volume 16. The particle suspension flows through analyzing volume 16 with the cells singulated. The cells which have been tagged with a distinct or characteristic dye are excited by the light beam 14. Scattered light is gathered by a lens system 17 and is focused onto detector 18 which provides a count of all cells which have traversed the volume whether labeled or not. Cells which have been tagged or labeled with a distinct or characteristic dye emit light at their corresponding wavelength. The light emitted by the tagged particles is gathered by a lens system 21 and applied to an acousto-optic tunable filter 22. The acousto-optic filter is driven by a transducer 23. The acoustic-optic filter is a solid-state electronically tunable band pass filter which uses a acousto-optic interaction inside an anisotropic medium. It allows the user to select and pass or transmit a single wavelength from the incoming light. The RF frequency applied to the transducer 23 controls the wavelength of the fluorescent light that is transmitted. The acousto-optic filter rapidly, sequentially and repetitively shifts the light wavelength which it passes so that as particles traverse the detection volume and emit fluorescent light at its characteristic wavelength, the light is periodically sampled and applied to the detector 24 a number of times during the transit time of that particle through the analyzing volume. Since the pass band is repetitively shifted and the process repeated during the transit time of a particle, the detector provides output pulses corresponding to the intensity of emitted fluorescent light at the characteristic wavelength of the label at the sampling intervals. As will be presently described, the signals can be reconstructed to provide a fluorescence trace for the particle. Since the wavelength pass band is repetitively shifted, sequential particle which fluoresce at different wavelengths are detected whereby to provide fluorescent traces for each particle.

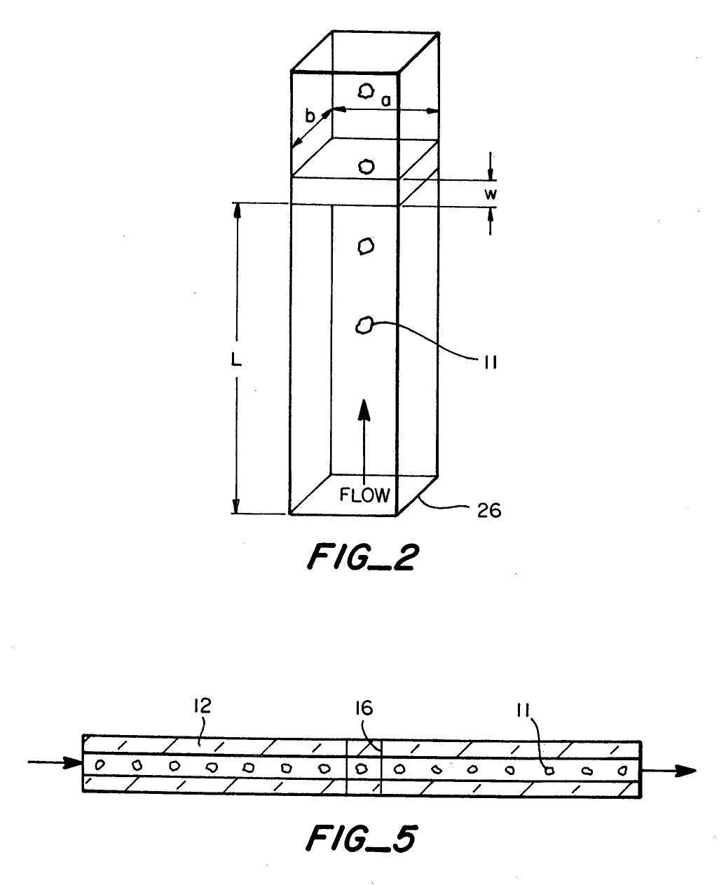

Referring particularly to FIG. 2, as a particle passes through the detection volume 16 the fluorescence is periodically detected when the wavelength pass band corresponds to the fluorescent wavelength of the particle. Assume a laser beam thickness W is 20 μm and the capillary dimensions a=b=0.1 mm, and the volume of sample from the inlet 26 to the detection volume is 200 nanoliters and the probe volume is 0.2 nanoliters. Assume further that the flow rate is 1 microliter per second, then the particle velocity is 100 mm/s and the transit time through the detection volume is 20 m/s. Assume that the acousto-optic filter can shift its pass band in 10 microseconds or less, this would result in sampling the fluorescent emission of each particle in a four color system about 12 times. It is apparent that if the acousto-optic filter can shift at a greater frequency, more samples can be taken or, in the alternative, a larger number of fluorescence colors can be detected and provide sufficient sampling points to reconstruct the fluorescence trace. It is also to be of particular note that the system requires small volumes of sample. The system is ideally suited for cell subset analysis wherein only small volumes of blood are available. This permits cell analysis which were, heretofore, difficult to perform because of the small volume of blood available, for example from infants, small animal species, mice, rats and other living organisms. The ability to analyze small volumes of blood from a living organism will allow characterization of blood cell populations without sacrificing the animals and will permit longitudinal studies where samples can be taken from a single animal at periodic intervals.

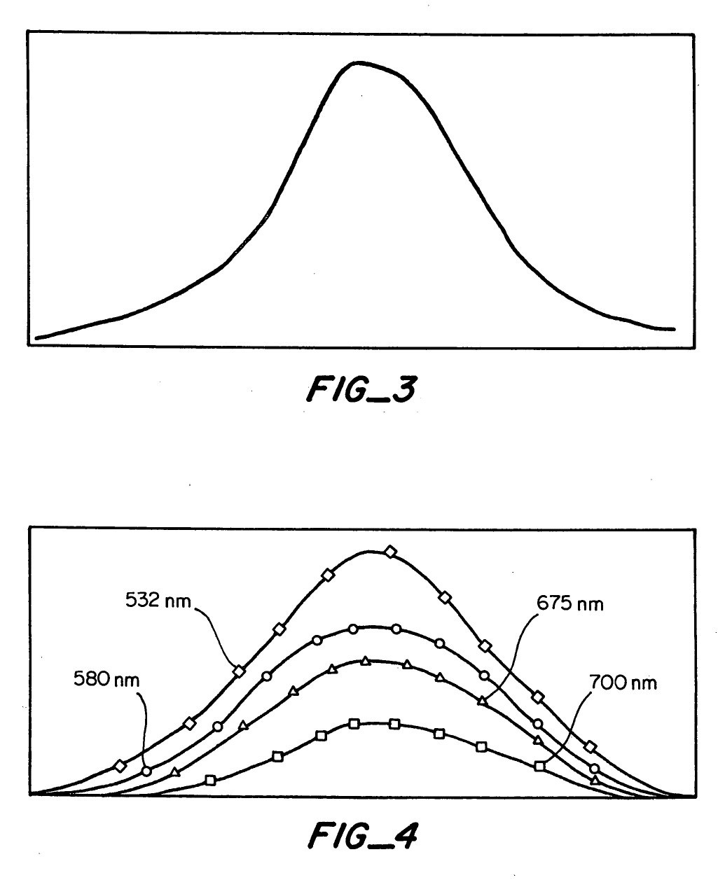

For example, consider a sample with particles which have been tagged or naturally fluoresce at different wavelengths, say 532 nm, 580 nm, 675 nm and 700 nm, passing through the detection volume. The traces shown in FIG. 4 show the sampling points for each of four particles obtained by rapidly, sequentially, and respectively detecting the fluorescence and using the sampling points to construct the traces for the four particles. It is seen that the amplitude of the signal increases as the particle travels into the detection volume and decreases as the particle leaves the detection volume. This provides a peak signal for each color.

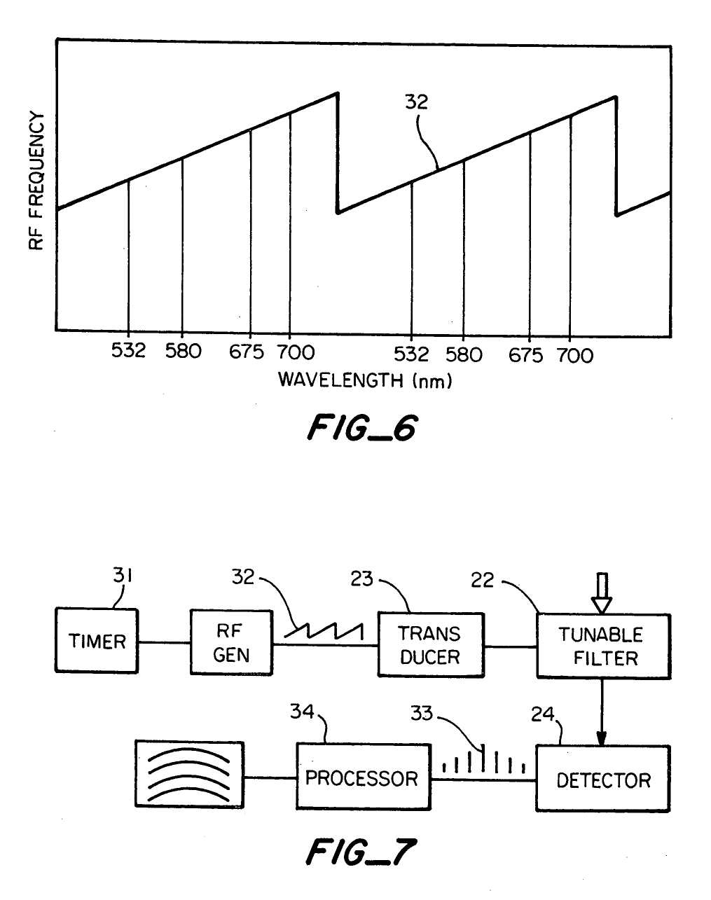

The acoustic-optic tunable filter passes light at a wavelength or frequency which is determined by the RF frequency of the drive voltage applied to the transducer 23. FIG. 6 is a schematic plot of pass wavelength as a function of frequency. If the RF frequency is periodically and repeatedly increased the pass band is also periodically and repeatedly increased. As an example, the wavelengths of the pass bands for the above-noted wavelengths is illustrated. Should there be particles which emit at other wavelengths the RF frequency could be adjusted to drive the AO filter at the appropriate pass band wavelength. In other words, the AO filter could be tuned to the maximum spectral emission of the particles. Although an AO filter is preferred and other tunable filters could be used. Referring to FIG. 7 a suitable circuit for controlling the tunable filter and constructing the traces for each particle is schematically shown. The circuit includes a source of timing pulses 31 which time the repetition of the RF frequency ramps 32. The transducer 23 is driven by the RF voltage and drives the tunable filter 22 which receives the fluorescent light and selectively passes it to the detector 24. The detector provides output pulses 33 having an amplitude corresponding to that of the impinging light. A processor 34 synchronized by the timer receives the voltage pulses and reconstructs the traces, FIG. 4, for each of the particles. A peak detector (not shown) can provide a signal pulse representating the amplitude and the peak from a number of particles can then be plotted as a function of wavelength.

Thus there has been provided a particle analyzer using a single channel to simultaneously measure a large number of fluorescent light parameters and provide information which permits characterization of particles which fluoresce at different wavelengths.

1. A multicolor particle analyzer including:
a capillary;
means for projecting a light beam through said capillary to illuminate a predetermined volume in said capillary;
means for causing a sample containing sample particles each tagged to fluoresce and emit light at a distinct wavelengths to flow along the capillary through said predetermined volume;
a tunable filter for receiving said emitted light and repetitively passing light at sequential wavelengths whereby to pass a number of light pulses for each of said particles at its distinct wavelength as it passes through said predetermined volume; and
a detector for detecting the output light from said acoustic-optic filter and provide an output pulse for each light pulse.

2. A multicolor particle analyzer as in claim 1 in which the tunable filter is an acousto-optic filter.

3. A multicolor particle analyzer as in claims 1 or 2 including a detector for detecting light scattered by said particles as they travel through the predetermined volume.

4. A multicolor particle analyzer for analyzing particles which emit light at distinct wavelengths as they pass through an analyzing volume comprising:
a tunable filter for receiving the emitted light and repetitively pass light at a sequential wavelengths including the distinct wavelengths; and
a single detector for receiving the light from the tunable filter and provide output signals for each distinct wavelength as the corresponding particle passes through the analyzing volume.

5. The method of analyzing particles which fluoresce and emit light at different distinct wavelengths responsive to excitation light which comprises the steps of:
causing the particles to flow through an analyzing region;
applying excitation light to the analyzing region to cause the particles to emit light at their distinctive wavelength as they pass through the analyzing region;
receiving the emitted light with a tunable optical filter to repetitively and sequentially pass light at said distinct wavelengths; and
detecting the light passed by the filter with a single detector to provide output signal representative of the particle emitting the distinct wavelength.

6. The method of claim 5 wherein the particles are caused to flow at a rate such that the light emitted by a particle is passed a number of times as the particle transits through the analyzing region.
